(19) United States
(12) Patent Application Publication
(10) Pub. No.: US 2008/0074382 A1
(43) Pub. Date: Mar. 27, 2008

(54) DISPLAY DEVICE, CONTROL METHOD THEREOF, AND BACKLIGHT UNIT USED THEREFOR

(76) Inventors: Sang-gil Lee, Seoul (KR); Seong-sik Shin, Seongnam-si (KR); Hyeon-yong Jang, Osan-si (KR); Sang-hoon Lee, Yongin-si (KR)

Correspondence Address: F. CHAU & ASSOCIATES, LLC, 130 WOODBURY ROAD, WOODBURY, NY, 11797, US

(21) Appl. No.: 11/779,920

(22) Filed: Jul. 19, 2007

(30) Foreign Application Priority Data
Jul. 20, 2006 (KR) 10-2006-0067919

(51) Int. Cl. G09G 3/36

(52) U.S. Cl. 345/102; 345/88

(57) ABSTRACT

A display device, including: a light source part having a plurality of light sources; a color sensing part having a dummy light source, and a color sensor sensing a color information of light emitted from the dummy light source; a light source driving part driving the light source part so that the light sources sequentially emit at least two colored lights with a predetermined period, and supplying power to the dummy light source; and a control part controlling the light source driving part depending on the sensed color information so that a color coordinate of the light sources has a predetermined reference value.

### CROSS-REFERENCE TO RELATED APPLICATION

This application claims priority from Korean Patent Application No. 2006-0067919, filed on Jul. 20, 2006, in the Korean Intellectual Property Office, the disclosure of which is incorporated herein by reference.

### BACKGROUND OF INVENTION

1. Technical Field

The present disclosure relates to a display device, a control method thereof, and a backlight unit used therefor and, more particularly, to a display device operated as an FSC (field sequential color) type or a CSD (color sequential display) type, a control method thereof, and a backlight unit used therefor.

2. Discussion of Related Art

Generally, a liquid crystal display device is one of the most popular display devices and includes a first substrate formed with thin film transistors, and a second substrate (liquid crystal panel) formed with an RGB color filter layer.

The liquid crystal display device supplies a white light emitted from a light source to the RGB color filter layer, and synthesizes RGB colors transmitted through the RGB color filter layer to display a desired color.

Recently, a liquid crystal display device of a CSD (color sequential display) type has been introduced. The CSD type uses three color light sources. The CSD type periodically turns on independent light sources of RGB colors in order, and applies a color signal corresponding to each pixel to be synchronized with the turn-on period of the light sources, thereby obtaining an image in full color. Since there is no need for dividing a pixel into sub pixels, the CSD type easily improves aperture ratio and yield, reduces the number of driving circuits necessary for every sub pixel to one third thereof, and needs no color filter layer.

The CSD type display does not accurately measure white balance or brightness with respect to a synthesized white light, however, because different colored lights instead of a white light are scanned at separate times. Accordingly, it is difficult to obtain uniform brightness and color in a liquid crystal panel practicing CSD.

### SUMMARY OF THE INVENTION

Accordingly, exemplary embodiments of the present invention, provide a display device, a control method thereof, and a backlight unit used therefor that uniformly maintains brightness and color.

Exemplary embodiments of the present invention can provide a display device, comprising: a light source part comprising a plurality of light sources; a color sensing part comprising a dummy light source, and a color sensor sensing a color information of light emitted from the dummy light source; a light source driving part driving the light source part so that the light sources sequentially emit at least two colored lights with a predetermined period, and supplying power to the dummy light source; and a control part controlling the light source driving part depending on the sensed color information so that a color coordinate of the light sources has a predetermined reference value.

According to an exemplary embodiment of the present invention, the color information comprises an electric signal corresponding to a gray scale of light, and the control part compares an electric signal corresponding to the reference value and the sensed electric signal, and controls the light source driving part to adjust power supplied to the light source if the difference therebetween exceeds a predetermined allowable range.

According to an exemplary embodiment of the present invention, the light source driving part comprises a PWM generating part, and the control part adjusts a PWM control signal supplied to the PWM generating part if the difference between the electric signal corresponding to the reference value and the sensed electric signal exceeds a predetermined allowable range.

According to an exemplary embodiment of the present invention, the electric signal comprises a voltage value; and the control part further comprises an A/D converter converting the voltage value into a digital signal.

According to an exemplary embodiment of the present invention, the light sources comprise a first light emitting diode respectively emitting a red light, a green light and a blue light.

In an exemplary embodiment of the present invention, the dummy light source comprises a plurality of second light emitting diodes respectively emitting a red light, a green light and a blue light.

In an exemplary embodiment of the present invention, the second light emitting diodes produce a simultaneous emitting period in which the red, green and blue lights are simultaneously emitted for sensing the color information.

According to an exemplary embodiment of the present invention, the control part controls the light source driving part so that the simultaneous emitting period is formed with a specific interval.

According to an exemplary embodiment of the present invention, the light source driving part comprises a plurality of sub light source driving parts for driving the first light emitting diode and the second light emitting diodes by the color of light, and the first light emitting diode and the second light emitting diodes emitting the same colored light are connected in parallel with the sub light driving part.

In an exemplary embodiment of the present invention, the number of light sources connected to the sub light driving part is greater than that of the dummy light source.

In an exemplary embodiment of the present invention, the display device further comprises a predetermined resistor connected in series to the dummy light source.

According to an exemplary embodiment of the present invention, the display device further comprises a circuit substrate, wherein the light source part is formed on a first surface of the circuit substrate, and the dummy light source is formed on a second surface of the circuit substrate.

According to an exemplary embodiment of the present invention, the display device further comprises a display panel supplied with light emitted from the light sources, wherein light emitted from, the dummy light source is not supplied to the display panel.

In an exemplary embodiment of the present invention, the display device further comprises a light blocking cover blocking an external light for the dummy light source.

The foregoing and/or other exemplary embodiments of the present invention can be achieved by providing a backlight unit, comprising: a circuit substrate; a light source part comprising a plurality of point light sources, and formed on a first surface of the circuit substrate; a color sensing part comprising a dummy point light source and a color sensor sensing a color information of light emitted from the dummy point light source, and formed on a second surface of the circuit substrate; a light source driving part driving the light source part so that the point light sources sequentially emit at least two colored lights with a predetermined period, and supplying power to the dummy point light source; and a control part controlling the light source driving part depending on the sensed color information so that a color coordinate of the light sources has a predetermined reference value.

According to an exemplary embodiment of the present invention, the dummy point light source produces a simultaneous emitting period in which red, green and blue lights are simultaneously emitted for sensing the color information.

According to an exemplary embodiment of the present invention, the control part controls the light source driving part so that the simultaneous emitting period is formed with a specific interval.

The foregoing and/or other exemplary embodiments of the present invention can be achieved by providing a control method of a display device, comprising: supplying power to a light source and a dummy light source; sensing color information of the light emitted from the dummy light source; and adjusting power supplied to the light source depending on the sensed color information, so that a color coordinate of the light source maintains a predetermined reference value.

According to an exemplary embodiment of the present invention, the color information comprises an electric signal corresponding to a gray scale of light, and the power adjusting stage includes steps of comparing an electric signal corresponding to the reference value and the sensed electric signal, and controlling power supplied to the light source if the difference therebetween exceeds a predetermined allowable range.

According to an exemplary embodiment of the present invention, the light source comprises a first light emitting diode respectively emitting a red light, a green light and a blue light, and the power supplying stage comprises supplying power to the first light emitting diode so that the first light emitting diode sequentially emits the red, green and blue lights with a predetermined period.

According to an exemplary embodiment of the present invention, the dummy light source comprises a second light emitting diode respectively emitting a red light, a green light and a blue light, and the power supplying stage comprises supplying power to the second light emitting diode so that the second light emitting diode simultaneously emits the red, green and blue lights.

### BRIEF DESCRIPTION OF THE DRAWINGS

Exemplary embodiments of the present invention will be understood in more detail from the following descriptions taken in conjunction with the accompanying drawings, in which:

FIG. 1 is an exploded perspective view illustrating a display device according to an exemplary embodiment of the present invention;

FIG, 2 is a rear view illustrating a light emitting diode substrate of the display device according to an exemplary embodiment of the present invention;

FIG. 3 is a sectional view illustrating the display device according to an exemplary embodiment of the present invention;

FIG. 4 is a control block diagram of the display device according to an exemplary embodiment of the present invention;

FIG. 5 is a schematic view illustrating a light source driving part of the display device according to an exemplary embodiment of the present invention;

FIG. 6 is a waveform illustration of light emitted from the light emitting diode of the display device according to an exemplary embodiment of the present invention;

FIG. 7 is a waveform illustration of light emitted from a light emitting diode of a display device according to an exemplary embodiment of the present invention; and

FIG. 8 is a control flowchart illustrating a control method of the display device according to an exemplary embodiment of the present invention.

### DETAILED DESCRIPTION OF EXEMPLARY EMBODIMENTS OF THE

Reference will now be made in detail to the exemplary embodiments of the present invention illustrated in the accompanying drawings, wherein like reference numerals refer to like elements throughout. The exemplary embodiments are described below so as to explain the present invention by referring to the figures.

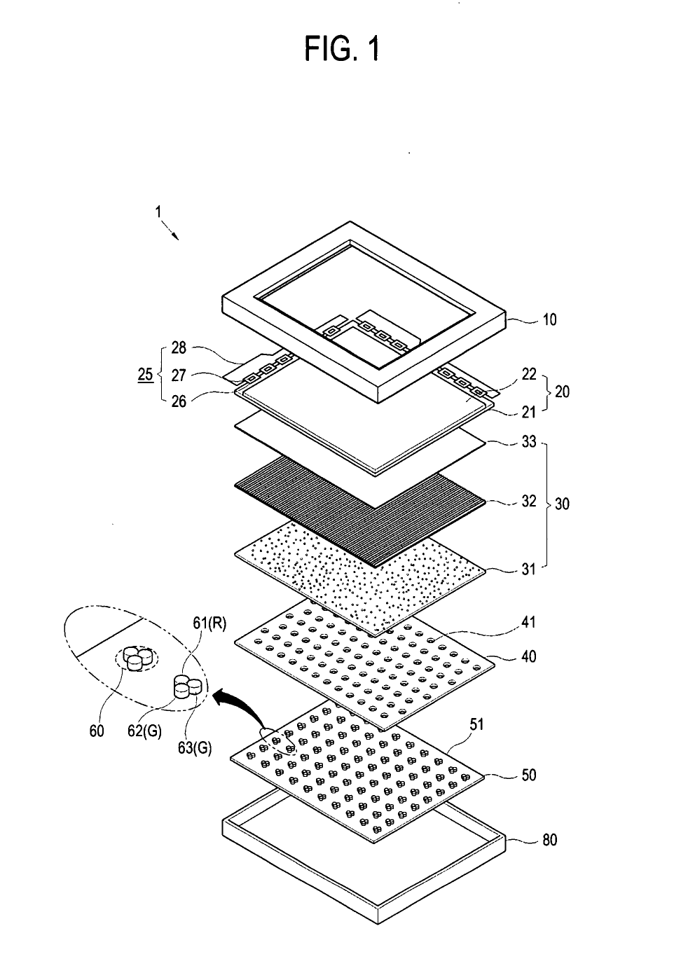

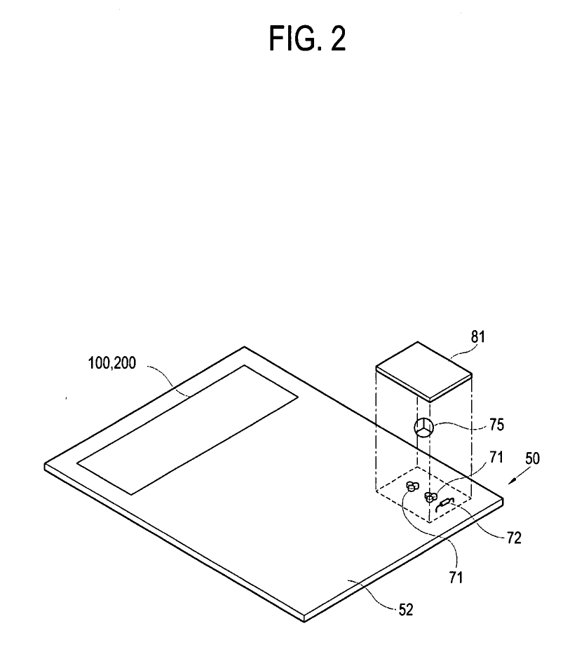

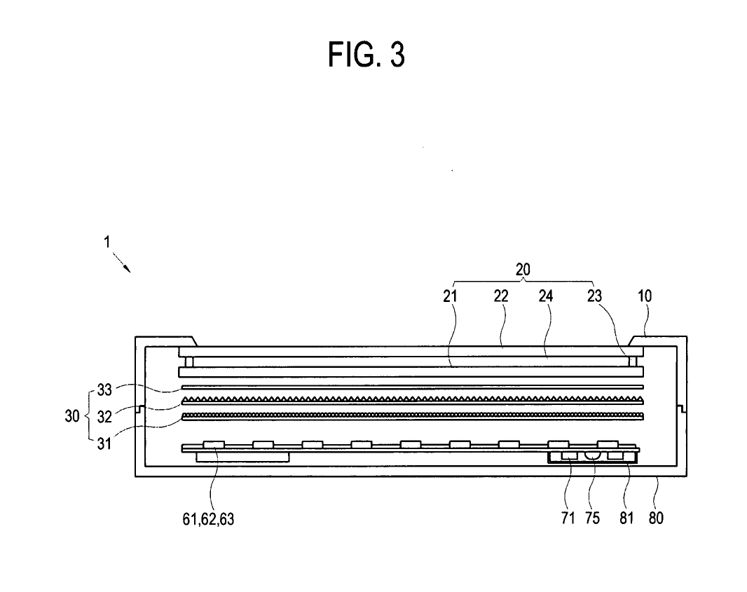

As shown in FIGS. 1 to 4, a liquid crystal display device 1 includes a liquid crystal display panel 20, a light adjusting member 30, a reflecting plate 40, a light emitting diode circuit substrate 50 that are positioned at a rear surface of the liquid crystal display panel 20 in order, and a light source part 60 mounted on the light emitting diode circuit substrate 50 and positioned at a light emitting diode accommodating hole 41. The light source part 60 comprises a point light source, and the point light source includes first light emitting diodes 61, 62 and 63 mounted to a first surface 51 of the light emitting diode circuit substrate 50 and supplying light to the liquid crystal display panel 20.

The liquid crystal display panel 20, the light adjusting member 30 and the light emitting diode circuit substrate 50 are accommodated between an upper chassis 10 and a lower chassis 80.

The liquid crystal display panel 20 includes a first substrate 21 formed with thin film transistors (not shown), a second substrate 22 facing the first substrate 21, a sealant 23 assembling both substrates 21 and 22 and forming a cell gap, and a liquid crystal layer 24 positioned between the substrates 21 and 22 and held in by the sealant 23. A black matrix (not shown) is formed in the second substrate 22 to prevent external light from entering the thin film transistors. The second substrate 22 according to the exemplary embodiment of the present invention does not include a color filter layer, and is supplied with lights having different colors in order by the light source part 60. That is, an image display is completed by means of a time base synthesis of red, green and blue lights instead of a spatially based synthesis thereof.

The liquid crystal display panel 20 is provided in a rectangular shape having a long side and a short side. The liquid crystal display panel 20 adjusts an arrangement of the molecules of the liquid crystal layer 24 to form a screen. Since the liquid crystal display panel 20 is not a light emitting element, the liquid crystal display panel 20 should be supplied with light from the first light emitting diodes 61, 62 and 63. A driving part 25 is provided to a side of the first substrate 21 to supply a driving signal. The driving part 25 includes an FPC (flexible printed circuit) 26, a driving chip 27 mounted on the FPC, and a PCB (printed circuit board) 28 connected to a side of the FPC 26. The driving part 25 comprises a COF (chip on film) type device. Alternatively, the driving part 25 may comprise a TCP (tape carrier package), a COG (chip on glass) or other known types. Alternatively, the driving part 25 may be formed to the first substrate 21 in a line forming process.

The light adjusting member 30 positioned to a rear side of the liquid crystal display panel 20 may include a diffusing plate 31, a prism film 32 and a protecting film 33.

The diffusing plate 31 includes a base plate and a coating layer comprising a bead formed to the base plate. The diffusing plate 31 diffuses light supplied from the first light emitting diodes 61, 62 and 63 to make the brightness thereof uniform.

The prism film 32 is formed with triangular prisms uniformly arranged on an upper surface thereof. The prism film 32 collects light diffused through the diffusing plate 31 in a vertical direction with respect to a plane of the liquid crystal display panel 20. The prism film 32 is typically provided as a pair, and each micro prism formed on the prism film 32 has a predetermined angle. Most of the light passing through the prism film 32 perpendicularly advances to supply a uniform brightness distribution. A reflecting polarizing film may be provided together with the prism film 32, or the reflecting polarizing film may be solely provided without the prism film 32 as necessary.

The protecting film 33 is uppermost positioned and protects the prism film 32 because it is liable to be scratched.

The reflecting plate 40 is provided over a part of the light emitting diode circuit substrate 50 on which the first light emitting diodes 61, 62 and 63 are not mounted. The reflecting plate 40 is provided with the light emitting diode accommodating holes 41 to correspond to arrangements of the first light emitting diodes 61, 62 and 63. A light emitting diode group comprising three first light emitting diodes 61, 62 and 63 is positioned to be aligned with each light emitting diode accommodating hole 41, and the size of the light emitting diode accommodating hole 41 may be slightly bigger than that of the light emitting diode group.

The reflecting plate 40 reflects light supplied from the light emitting diode circuit substrate 50 to the diffusing plate 31. The reflecting plate 40 may be formed of PET (polyethylene terephthalate), or PC (poly carbonate), and may be laminated with silver or aluminum. The reflecting plate 40 may have a sufficient thickness so as not to be wrinkled by the strong heat generated from the first light emitting diodes 61, 62 and 63.

The light emitting diode circuit substrate 50 has the same rectangular shape as the liquid crystal display panel 20. The light source part 60 shown in FIG. 1 is formed on the first surface 51 of the light emitting diode circuit substrate 50 facing the liquid crystal display panel 20, and a color sensing part 70, a light source driving part 200 and a control part 100 are formed to a second surface 52 of the light emitting diode circuit substrate 50 facing the lower chassis 80. Since the first light emitting diodes 61, 62 and 63 generate a lot of heat, the light emitting diode circuit substrate 50 may be mainly formed of aluminum with good thermal conductivity. The liquid crystal display device 1 may further include a heat pipe, a radiating fin, a cooling fan, or other known means to facilitate heat radiation. Alternatively, the light emitting diode circuit substrate 50 may have other shapes, and may comprise a plurality of bars extending along a long side of the liquid crystal display panel 20.

The first light emitting diodes 61, 62 and 63 are mounted on the first surface 51 of the light emitting diode circuit substrate 50, and are disposed over all of the rear surface of the liquid crystal display panel 20. The first light emitting diodes 61, 62 and 63 include a first red light emitting diode 61 emitting a red light, a first green light emitting diode 62 emitting a green light, and a first blue light emitting diode 63 emitting a blue light. The three light emitting diodes 61, 62 and 63 emitting different colored lights comprise a single group together. Three light emitting diodes 61, 62 and 63 are disposed to form a regular triangle. Ten light emitting diode groups are arranged along a single row parallel to a long side of the light emitting diode circuit substrate 50, and the light source part 60 includes eight rows in total. The first light emitting diodes 61, 62 and 63 include a chip emitting light, a lead connecting the chip and the light emitting diode circuit substrate 51, a plastic mold accommodating the lead and surrounding the chip, and a silicon lens positioned to an upper part of the chip.

The light source part 60 is driven by the light source driving part 200, and emits red, green and blue lights in order, each with a predetermined period. In this exemplary embodiment, there is no color filter layer provided to the second substrate 22. Since the red, green and blue lights are emitted at different times, a white light can not be emitted.

The single group of the first light emitting diodes 61, 62 and 63 may be formed by other configurations. The single group thereof may further include an additional light emitting diode emitting a red light or a green light so that four light emitting diodes form a single group, or may include a further light emitting diode emitting a white light as necessary.

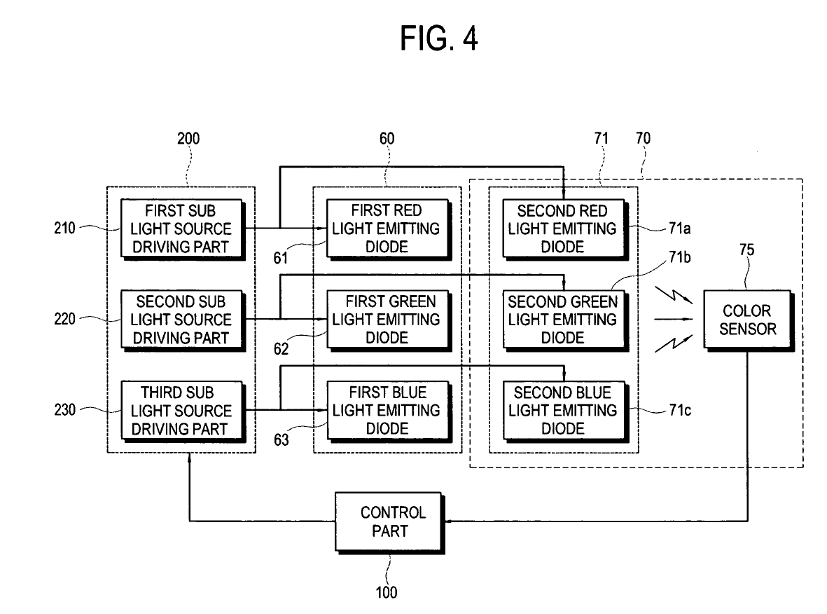

The color sensing part 70 shown in FIG. 4 and formed on the second surface 52 of the light emitting diode circuit substrate 50 includes a dummy light source 71, and a resistor 72 electrically connected with a color sensor 75 and the dummy light source 71. The color sensing part 70 faces the light source part 60 to interpose the light emitting diode circuit substrate 5Q therebetween. Since the light emitting diode circuit substrate 50 has good thermal conductivity and a small thickness, the first surface 51 and the second surface 52 have the same temperature.

The dummy light source 71 emits a white light under the same condition as the light source part 60 provided to the first surface 51, and compensates for colors of the light source part 60. Since the first light emitting diodes 61, 62 and 63 are not energised simultaneously to form a white light, it is difficult to synthesize a white light for compensating for color and brightness. Accordingly, a white light emitted, from the dummy light source 71 is sensed under a uniform temperature condition which has the most critical influence on a light emitting property of a light emitting diode. Light emitted from the dummy light source 71 is not mixed with light emitted from the light source part 60, and is not supplied to the liquid crystal display panel 20 so as to have no influence on the light emitted from the first surface 51 of the light emitting diode circuit substrate 50.

Since the first surface 51 and the second surface 52 of the light emitting diode circuit substrate 50 provided with the light source part 60 and the dummy light source 71 are maintained at the same temperature, a separate temperature control system may not be further required.

The dummy light source 71 includes second light emitting diodes 71a, 71b and 71c including a second red light emitting diode 71a, a second green light emitting diode 71b and a second blue light emitting diode 71c respectively emitting a red light, a green light and a blue light like the first light emitting diodes 61, 62 and 63. As shown in FIG. 2, the color sensing part 70 includes two light emitting diode groups 71.

The first light emitting diodes 61, 62 and 63 of the light source part 60 and the second light emitting diodes 71a, 71b and 71c of the color sensing part 70 preferably but not necessarily have the same properties.

The resistor 72 is connected in series with the second light emitting diodes 71a, 71b and 71c. Light emitting diodes emitting the same colored lights are connected in series among the first light emitting diodes 61, 62 and 63 arranged in the same row. Also, light emitting diodes emitting the same colored lights are connected in series among the dummy light sources 71 of the color sensing part 70. The first light emitting diodes 61, 62 and 63 and the second light emitting diodes 71a, 71b and 71c emitting the same colored lights are connected in parallel with the light source driving part 200. That is, the first light emitting diodes 61, 62 and 63 and the second light emitting diodes 71a, 71b and 71c emitting the same colored lights are supplied with the same power. Since power of the same level is supplied to different quantities of light emitting diodes, a voltage across one of the first light emitting diodes 61, 62 and 63 is smaller than a voltage across one of the second light emitting diodes 71a, 71b and 71c. Since the voltages across the light emitting diodes are different, an environment and a light emitting condition of the light emitting diodes become different. More specifically, when the amount of heat generated by the light emitting diode becomes different by reason of the voltage difference, the temperatures of the first surface 51 and the second surface 52 of the light emitting diode circuit substrate 50 become different. Accordingly, it becomes difficult to sense light emitted from the light source part 60 on the first surface 51 by means of the color sensor 75 provided on the second surface 52. The resistor 72 is connected to the second light emitting diodes 71a, 71b and 71c to prevent the above problem. The total resistance of the resistor 72 and all second light emitting diodes 71a, 71b and 71c connected to the resistor 72 is the same as the resistance of all the first light emitting diodes 61, 62 and 63. The resistor 72 has a resistance selected to satisfy the above condition.

The color sensor 75 detects color information from white light emitted from the second light emitting diodes 71a, 71b and 71c. The color sensor 75 sensing the white light supplies the control part 100 with an electric signal corresponding to a gray scale of light by the colors of red, green and blue, respectively. The electric signal corresponding to the color information according to an exemplary embodiment of the present invention comprises a voltage. Alternatively, the electric signal corresponding to the color information may comprise a current. The color sensor 75 may comprise a single chip capable of receiving a white light to divide it into a plurality of colors, measuring a gray scale by color, and outputting a voltage corresponding to the gray scale. The color sensor 75 is preferably provided at a position in which red, green and blue lights emitted from the second light emitting diodes 71a, 71b and 71c are sufficiently mixed.

A light blocking cover 81 blocks external light with respect to the dummy light source 71 so that the color sensor 75 senses only light emitted front the dummy light source 71. The light blocking cover 81 is preferably but not necessarily black so that the dummy light source 71 and color sensor 75 are disposed in a dark space.

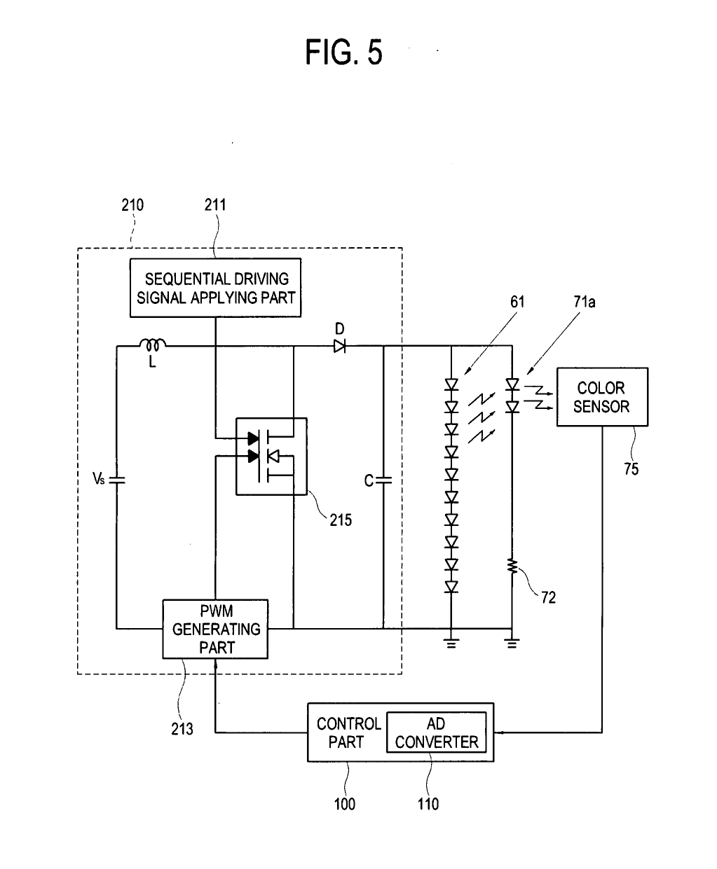

FIG. 4 is a block diagram of the light producing elements of the display device according to an exemplary embodiment of the present invention, and FIG. 5 is a schematic illustrating a light source driving part of the display device according to the exemplary embodiment of the present invention. Hereinafter, a control method of the display device using the dummy light source will be described by referring to FIGS. 4 and 5.

As shown in FIG. 4, the light source driving part 200 includes a plurality of sub light source driving parts 210, 220 and 230. The sub light source driving parts 210, 220 and 230 respectively drive the first light emitting diodes 61, 62 and 63 and the second light emitting diodes 71a, 71b and 71c emitting the same colored lights. Referring to FIG. 1, the first light emitting diodes 61, 62 and 63 are arranged in eight rows parallel to the long side of the liquid crystal display panel 20. The first red light emitting diode 61, the first green light emitting diode 62 and the first blue light emitting diode 63 arranged in one row are respectively driven by the first sub light source driving part 210, the second sub light source driving part 220 and the third sub light source driving part 230. Accordingly, the light source driving part 200 includes twenty four sub light source driving parts in ail. Each sub light source driving part 210, 220 and 230 supplies power to the first light emitting diodes 61, 62 and 63 and the second light emitting diodes 71a, 71b and 71c, and adjusts the power supplied to the first light emitting diodes 61, 62 and 63 depending on control of the control part 100.

The control part 100 independently controls the respective sub light driving parts 210, 220 and 230 depending on the color information sensed by the color sensor 75, so that a color coordinate of the light source part 60 has a predetermined reference value. The liquid crystal display device 1 of FIG. 1 has a desirable color coordinate value with respect to light emitted from the light source part 60. The control part 100 stores a reference color coordinate value as an index for brightness and color of the light, and a reference gray scale voltage value for light by color corresponding to the reference color coordinate value. For example, reference gray scale voltage values for red, green and blue lights are respectively assumed to be 5V, 4V and 3V when the reference color coordinate value is (0.28, 0.29). When it is determined that gray scale voltages of the respective light emitting diodes sensed by the color sensor 75 do not correspond to the reference gray scale voltage and the difference exceeds a predetermined allowable range and that brightness and color of the light are abnormal, the control part 100 adjusts the power supplied to the light emitting diode.

FIG. 5 illustrates the first red light emitting diodes 61 emitting a red light, the second red light emitting diodes 71a connected in parallel therewith and emitting a red light, and the first sub light source driving part 210 driving them. Ten first red light emitting diodes 61 are connected in series, and are connected in parallel to the first sub light source driving part 210. Also, two series-connected second light emitting diodes 71a are connected in parallel to the first sub light source driving part 210. The resistor 72 is connected in series with the second light emitting diodes 71a.

The first sub light source driving part 210 includes a power source Vs, a sequential driving signal applying part 211, a PSM generating part 213 and a switching part 215. The first sub light source driving part 210 further includes a coil L accumulating the power depending upon on and off of the switching part 215 to raise the power voltage, a diode D for smoothing the power, and a capacitor C stabilising the power by operating as a filter.

The sequential driving signal applying part 211 applies a control signal with respect to sequential driving to the switching part 215 so that the light source part 60 sequentially supplies power to the different colored lights.

The switching part 215 regulates a current supplied to the first red light emitting diode 61 from the power source Vs. The switching part 215 may comprise an MOSFET (metal oxide semiconductor field effect transistor) turned on and off depending on a PWM control signal produced by the PWM generating part 213. A switching part (not shown) is further provided for supplying a boost power to the second red light emitting diode 71a. The switching part connected to the second red light emitting diode 71a is not controlled depending on a control with respect to the sequential driving by the sequential driving signal applying part 211, but is turned on and off by only a PWM control from the PWM generating part 215.

The PWM generating part 213 controls the switching part 215 by a PWM control signal so that the first sub light source driving part 210 outputs a uniform driving power enabling the first and second red light emitting diodes 61 and 71a to emit lights having a predetermined directed brightness. The PWM generating part 213 receives a lighting control signal for the first and second red light emitting diodes 61 and 71a from the control part 100 to repeatedly turn on and off the switching part 215.

The first sub light source driving part 210 may also include other known configurations. For example, the first sub light source driving part 210 may include a regulator instead of the PWM generating part 213.

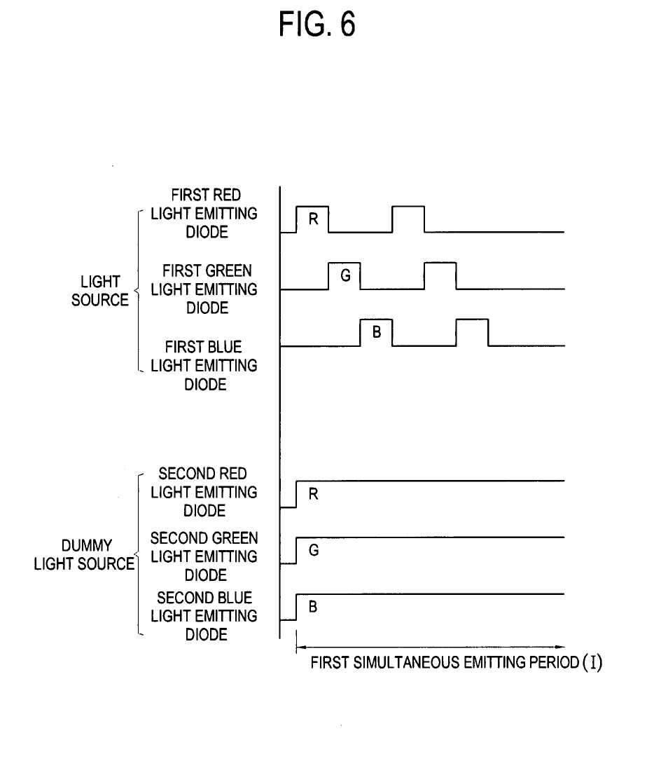

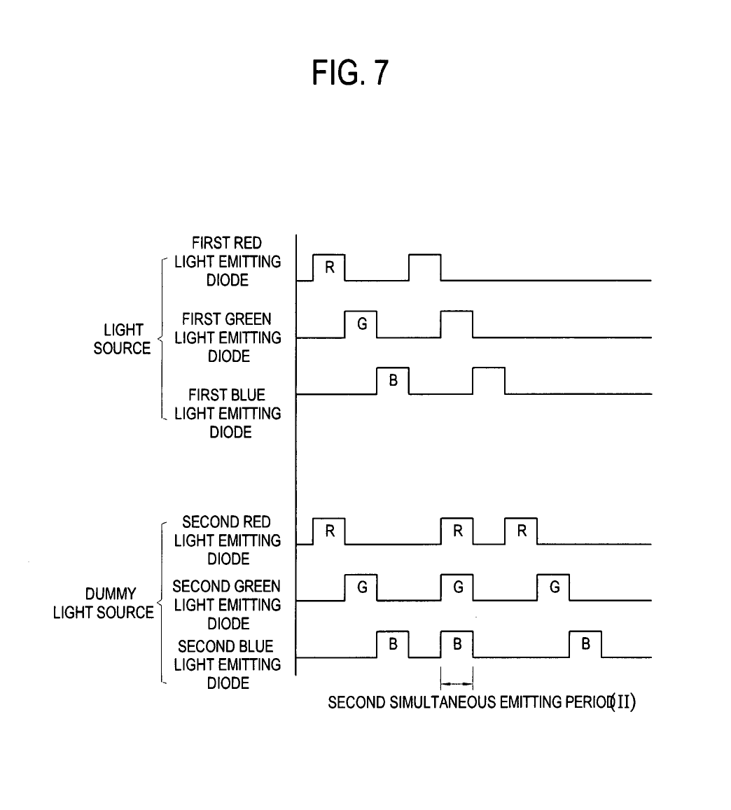

The color sensor 75 senses white light emitted from the second light emitting diodes 71a, 71b and 71c, and supplies color information to the control part 100. FIGS. 6 and 7 illustrate simultaneous emitting periods I and II, respectively, of the second light emitting diodes 71a, 71b and 71c. As shown in FIG. 6, the first light emitting diodes 61, 62 and 63 sequentially emit a red light, a green light and a blue light so that the red, green and blue lights are emitted at different times. The dummy light source 71, however, continuously and simultaneously emits red, green and blue lights. A first simultaneous emitting period I refers to a period in which the dummy light source 71 simultaneously emits the red, green and blue lights. There is no period in which three colored lights are simultaneously emitted in the conventional sequential display type and, accordingly, it was difficult to sense a white light. The liquid crystal display device 1 according to the exemplary embodiment of the present invention, however, includes the separate dummy light source 71 for sensing light independent of the light source part 60 so that the dummy light source 71 provides a period in which three colored lights are simultaneously emitted, thereby permitting conveniently sensing the white light.

FIG. 7 illustrates light emitting states of first and second light emitting diodes 61, 62, 63, 71a, 71b and 71c according to an exemplary embodiment of the present invention. As shown therein, the second light emitting diodes 71a, 71b and 71c do not continuously form simultaneous emitting periods, but form second simultaneous emitting periods II at specific intervals. The second light emitting diodes 71a, 71b and 71c emit a white light at every specific interval while being driven by a sequential display like the first light emitting diodes 61, 62 and 63. The color sensor 75 can sense the white light during the second simultaneous emitting period II. When the second light emitting diodes 71a, 71b and 71c are driven, it is unnecessary to continuously supply power to all light emitting diodes, thereby reducing power consumption. As long as the color sensor 75 periodically senses the white light, an interval and a continuous time of the simultaneous emitting period of the second light emitting diodes 71a, 71b and 71c may be variously determined.

As shown in FIG. 5, the control part 100 includes an A/D converter 110 converting a color information supplied from the color sensor 75 into a digital signal. The color information according to the exemplary embodiment comprises a voltage value corresponding to a gray scale of light. The A/D converter 110 receives a gray scale voltage relating to each color from the color sensor 75, and converts it into a digital signal capable of being processed. The control part 100 controls the PWM control signal generated by the PWM generating part 213 of the first sub light source driving part 210 depending on the converted digital signal.

If a sensed gray scale voltage is greater than the reference gray scale voltage and the difference exceeds a predetermined allowable range, a lower power having a decreased level compared with an existing power is supplied to the first red light emitting diode 61. To accomplish this, the width of a turn-on pulse of the signal fed to the switching part 215 is reduced. That is, the control part 100 outputs a PWM control signal for reducing the duty ratio of the switching part 215.

If a sensed gray scale voltage is smaller than the reference gray scale voltage and the difference exceeds a predetermined allowable range, the control part 100 increases the width of the turn-on pulse of the signal fed to the switching part 215.

Accordingly, sensing of the white light and adjusting of the PWM control signal are continuously accomplished so that the reference gray scale voltage can be applied to the first light emitting diodes 61, 62 and 63, thereby maintaining a desired color coordinate.

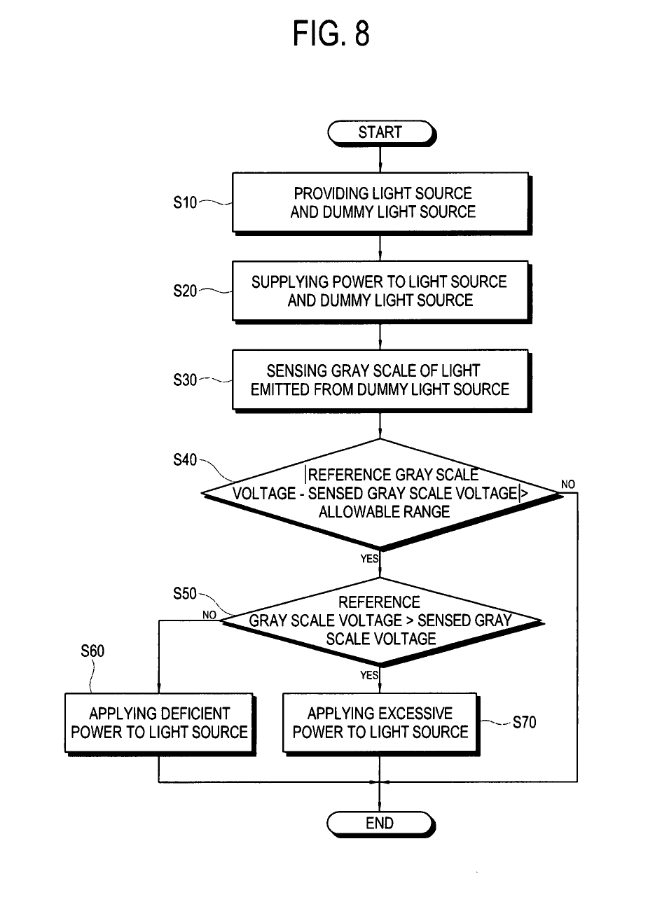

FIG. 8 is a flowchart of a control method for the liquid crystal display device according to an exemplary embodiment of the present invention. Hereinafter, a control method, of the liquid crystal display device according to the exemplary embodiment of the present invention will be described by referring to FIG. 8.

Initially, the light source part 60 supplying light to the liquid crystal display panel 20 and the dummy light source 71 for sensing a white light are provided (S10), and then power is supplied to the light source part 60 and the dummy light source 71 (S20). In this exemplary embodiment, the first light emitting diodes 61, 62 and 63 of the light source part 60 are driven by a sequential display method, and the second light emitting diodes 71a, 71b and 71c of the dummy light source 71 form the simultaneous emitting periods I and II simultaneously emitting a white light.

The color sensor 75 senses a gray scale voltage corresponding to a color information of light emitted from the dummy light source 71 during the simultaneous emitting periods I and II (S30).

The control part 100 stores a reference gray scale voltage corresponding to a desirable color coordinate of light emitted from the light source part 60. The control part 100 compares the sensed gray scale voltage with the reference gray scale voltage, and determines whether the difference between the reference gray scale voltage and the sensed gray scale voltage exceeds a predetermined allowable range or not (S40).

If the difference does not exceed the predetermined allowable range, that is, if the light emitted from the light source part 60 satisfies the color coordinate, an existing PWM control signal is maintained.

If the difference exceeds the predetermined allowable range and, thus, it is necessary to adjust the power supplied to the light source part 60, it is determined whether the reference gray scale voltage is bigger than the sensed gray scale voltage or not (S50).

If the reference gray scale voltage is smaller than the sensed gray scale voltage, the duty ratio of the switching part 215 is reduced and a deficient, that is, reduced, power is supplied to the light source part 60 (S60). If the reference gray scale voltage is greater than the sensed gray scale voltage, the duty ratio of the switching part 215 is raised and an excessive, that is, increased, power is supplied to the light source part 60 (S70).

As described above, exemplary embodiments of the present invention provide a display device, a control method thereof, and a backlight unit used therefor uniformly maintaining brightness and color.

Although exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display device, comprising:
a light source part comprising a plurality of light sources;
a color sensing part comprising a dummy light source, and a color sensor sensing color information of light emitted from the dummy light source;
a light source driving part driving the light source part so that the light sources sequentially emit at least two colored lights with a predetermined period, and supplying power to the dummy light source; and
a control part controlling the light source driving part depending on the color information sensed by the color sensing part, so that a color coordinate of the light sources has a predetermined reference value.

2. The display device according to claim 1, wherein the color information comprises an electric signal corresponding to a gray scale of light, and
the control part compares an electric signal corresponding to the reference value and a sensed electric signal from the color sensor, and controls the light source driving part to adjust power supplied to the light sources if the difference therebetween exceeds a predetermined ε range.

3. The display device according to claim 2, wherein the light source driving part comprises a PWM generating part, and
the control part adjusts a PWM control signal supplied to the PWM generating part if the difference between the electric signal corresponding to the reference value and the sensed electric signal exceeds a predetermined range.

4. The display device according to claim 2, wherein the electric signal comprises a voltage value; and
the control part further comprises an A/D converter converting the voltage value into a digital signal.

5. The display device according to claim 1, wherein the plurality of light sources comprise first light emitting diodes respectively emitting a red light, a green light and a blue light.

6. The display device according to claim 5, wherein the dummy light source comprises a plurality of second light emitting diodes respectively emitting a red light, a green light and a blue light.

7. The display device according to claim 6, wherein the second light emitting diodes are energized in a simultaneous emitting period in which the red, green and blue lights are simultaneously emitted for sensing the color information.

8. The display device according to claim 7, wherein the control part controls the light source driving part so that the simultaneous emitting period is formed with specific intervals.

9. The display device according to claim 8, wherein the light source driving part comprises a plurality of sub light source driving parts for driving the first light emitting diodes and the second light emitting diodes based on a color of light, and the first light emitting diodes and the second light emitting diodes emitting the same colored light are connected in parallel with the sub light driving parts.

10. The display device according to claim 9, wherein a number of the light sources connected to the sub light driving part is greater than a number of the dummy light source connected to the sub light driving part.

11. The display device according to claim 10, further comprising a resistor connected in series with the dummy light source.

12. The display device according to claim 1, further comprising a circuit substrate,
wherein the light source part is formed on a first surface of the circuit substrate, and the dummy light source is formed a second surface of the circuit substrate opposite to the first surface.

13. The display device according to claim 12, further comprising a display panel supplied with light emitted from the light sources,
wherein light emitted from the dummy light source is prevented from being supplied to the display panel.

14. The display device according to claim 1, further comprising a light blocking cover blocking external light from impinging on the dummy light source.

15. A backlight unit, comprising:
a circuit substrate;
a light source part comprising a plurality of point light sources and formed on a first surface of the circuit substrate;
a color sensing part comprising a dummy point light source and a color sensor sensing color information of light emitted from the dummy point light source and formed on a second surface of the circuit substrate opposite to the first surface;
a light source driving part driving the light source part so that the point light sources sequentially emit at least two colored lights with a predetermined period and supplying power to the dummy point light source; and
a control part controlling the light source driving part depending on the color information sensed by the color sensor, so that a color coordinate of the point light sources has a predetermined reference value.

16. The backlight unit according to claim 15, wherein the dummy point light source operates with a simultaneous emitting period in which red, green, and blue lights are simultaneously emitted for sensing the color information.

17. The backlight unit according to claim 16, wherein the control part controls the light source driving part so that the simultaneous emitting period is formed with a specific interval.

18. A control method of a display device, comprising:
supplying power to a light source and to a dummy light source;
sensing color information of light emitted from the dummy light source; and
adjusting power supplied to the light source depending on the sensed color information so that a color coordinate of the light source maintains a predetermined reference value.

19. The control method of a display device according to claim 18, wherein the color information comprises an electric signal corresponding to a gray scale of light, and
the adjusting of power comprises comparing an electric signal corresponding to the reference value and the sensed electric signal, and controlling power supplied to the light source if the difference therebetween exceeds a predetermined range.

20. The control method of a display device according to claim 18, wherein the light source comprises a first light emitting diode respectively emitting a red light, a green light and a blue light, and
the supplying of power comprises supplying power to the first light emitting diode so that the first light emitting diode sequentially emits the red, green and blue lights with a predetermined period.

21. The control method of the display device according to claim 20, wherein the dummy light source comprises a second light emitting diode respectively emitting a red light, a green light and a blue light, and
the supplying of power comprises supplying power to the second light emitting diode so that the second light emitting diode simultaneously emits the red, green and blue lights.
